(19) United States
(12) Patent Application Publication
(10) Pub. No.: US 2004/0006512 A1
(43) Pub. Date: Jan. 8, 2004

(54) Method of paying for a service

(75) Inventor: Aldo Rebsamen, Wil (CH)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS TRANSIT TELEMATIC SYSTEMS AG, NEUHAUSEN AR. (CH)

(21) Appl. No.: 10/611,983

(22) Filed: Jul. 3, 2003

Related U.S. Application Data
(63) Continuation of application No. PCT/EP01/14796, filed on Dec. 14, 2001.

(30) Foreign Application Priority Data
Jan. 9, 2001 (EP) 01 100 498.3

(51) Int. Cl. G06F 17/60

(52) U.S. Cl. 705/16

(57) ABSTRACT

When registering electronic tickets by means of a transmitter/receiver unit located in a railway carriage, for charging purposes data is created in a remote computer system which yields a movement profile for the persons using such tickets. For the anonymous prepaid registration of tickets it is proposed that a shadow account be maintained on the tickets to which postings are made using provisional tariff units contained in transmitted information units. In the remote computer system, a booking or posting is made to an account assigned to the respective ticket, using definitive tariff units contained in tariff tables. When a prepayment is made or at certain points in time the balance of the shadow account is synchronized with the balance on the remote computer system. As a result of the fact that the value of the provisional tariff unit is greater than that of the definitive tariff unit and/or that a discounting scheme can be implemented on the account on the remote computer system, a safety measure of excess balance is present on the ticket account balance.

### CONTINUATION DATA

The present application is a continuation of international application PCT/EP01/14796, filed Dec. 14, 2001; and further claims priority to European patent application 01100498.3, filed Jan. 9, 2001; both of which are herein incorporated by reference.

### BACKGROUND OF THE INVENTION

The present invention relates to a method of paying for a service and more particularly to use of an electronic card with access to a remote account for paying for and obtaining a particular service. Such service may include mass transportation such as use of a subway, train, and the like. The present inventive method takes into account a general desire for anonymity. This is especially true when the present invention is applied to the field of mass transportation, given that one's movement's could be tracked by simply reviewing one's purchase record.

International patent application WO 01/20557 A1 discloses a service registration system and method. The system and method use a portable ticket to obtain the service. The ticket includes a transmitter module. The method includes the steps of storing in a remote computer the registration of and purchase of the service. The remove computer includes an account associated with the portable ticket. When the purchase is stored in the remove computer, the account is debited accordingly. The holder of the portable ticket is then invoiced on a monthly basis. This method requires that the identification of the card holder be known. Accordingly, a disadvantage of the this method is that a profile of the card holder, based upon a history of purchases, can be generated. Such data may further not be in the card holder's control, thereby given rise to the potential for abuse.

In mobile communications following the Global System for Mobile Communication (GSM) system, it is possible to use a special Subscriber Identity Module (SIM) card to implement real-time charging for a service purchased without the network operator knowing the identity of the customer. Here, macros are present on the SIM card which, together with the register assigned to the Home Location Register (HLR) cause the charging of units to be debited from a stored credit balance with the remaining credit balance displayed on the display of the mobile telephone device. When the credit balance has been used up, a connection cleardown or shutdown is forced by means of a disconnect. Consequently, no further chargeable connections are possible. By using a so-called Valuecard, which can be purchased at many outlets, it is possible to once again create a credit balance in a register assigned to the ELR. As a result, no association of SIM card or subscriber number with the user is possible without additional actions. Greater user anonymity is effected. This anonymity is still maintained even if the identification of the person in question were to be ascertained when purchasing a SIM card because the Valuecard can only be assigned to a SIM card when a credit balance is loaded.

ComTec 2/1997 p. 16-20 of Swiss Telecom PTT describes a method for a GSM prepaid system in which the charge data is independently processed and monitored both on the network side and on the subscriber side. To this end, an Advice of Charge Charging service (AOCC) is required. This method has the advantage that attempted fraudulent use can be reliably detected and immediately countered on the network side. Such countering may include initiating a disconnect or escalatory measures such as blocking of the secret identification number International Mobile Subscriber Identity (IMSI).

A further debiting method using centrally stored tariff tables and a direct charging to the user's SIM card is disclosed in WO 99/41919. The advantageous aspect of this method is the fact that no further billing system is required.

The aforementioned methods which are commonly encountered in mobile communications are limited to application within the communication field. In the communication field, it is possible to make use of the telecommunication equipment and other elements unique to telecommunication to effect anonymous payment. The above described methods may not always be applied to other non-telecommunication fields to effect such payment. One such field includes mass transportation. The charging of fares for mass transportation cannot be effected by the above methods because:

i) If a credit balance on a ticket is used up during a journey, the passenger in question cannot simply be ushered out of the vehicle;

ii) Regardless of the payment method, namely debit or credit system, a discount system for frequent travelers and/or multiple travelers (family tickets) may not be available;

iii) vehicle tariffs are position dependent. Therefore, the position of the vehicle at all times must be known. Tariffs may not necessarily be based simply on a distance unit traveled by the vehicle, as distance and tariff kilometers may not always correspond. Likewise, charging by the mere time spent in a vehicle unfairly burdens the passenger for traffic and other transportation obstructions (technical failures and the like).

iv) There are considerable difficulties associated with maintaining continuously updated tariff tables in vehicles of an integrated transport network. The tariffs are dependent upon the time of day and require a fairly stable time base. Moreover, in tunnels the communication between a central unit and a vehicle cannot always be maintained or guaranteed.

In EP 0 971 320 A1, a vehicle parking system is disclosed in which a transponder is coupled with an add-on device. The transponder and add-on device are intended for use in a vehicle. If no link can be established with an external or remote computer system or if a link is interrupted, the remaining permitted parking time is counted down in the add-on device with an assumed value per unit of money. On the departure of the vehicle containing the transponder and the add-on device, a communication takes place with the external computer system such that the actual amount can be determined for the invoicing process. However, this method is suitable only for payment using a credit method.

### SUMMARY OF THE INVENTION

An object of the present invention is to address the above discussed user desire for anonymity with the purchase of a service. A further object is effecting payment for such solicited service in a similar anonymous way. Such payments are to be effected without the need to know the current tariff for the particular service being sought. A still further object is to provide a service payment and registration method which is convenient for the user, both in application and in service. Such convenient application includes automatic registration with a service without user intervention. Automatic registration includes the act of registration and payment. Such convenient service may include family discounts, frequent use discounts, and the like.

These and other objects and advantages are effect by the present inventive method. The present method comprises use of a card with storage and communication means. Display means may also be included. A shadow account is maintained in the storage means and may be selectively displayed, in response to a switch or broadcast signal, upon the display means. The card may communicate with a local transceiver. The account may also comprise a point account, credit account, or any other type of account comprising a measurable quantity of valued items (or data). The transceiver serves as an intermediary between the card holder and a remote computer. The presence of the card in a particular zone, a service registration zone, may be considered equivalent to an automatic registration or request for service. The registration zone may be predefined by physical boundaries as well as a broadcast range of the transceiver. Of course, more than one transceiver may be used. When the card is detected an exchange of information proceeds. Via the exchange, a determination may be made of whether a sufficient balance exists for a particular service. If sufficient funds exist, the registration is granted. As the transceiver may not always be in communication with the remote computer, a provisional tariff, based upon the particular service, may be booked to a shadow account maintained in the card storage means. When communication is re/established or on an ir/regular basis an actual tariff for the particular service may be booked to an actual account maintained by the remote computer, and in particular stored in the computers storage means as records associated with the respective ticket or card. Relevant information for this step may be provided by the transceiver upon booking, the actual account becomes updated, and the updated account is then transmitted to the card where the amount of the updated account replaces the current shadow account balance. Accordingly, a flexibility exists with respect to location of service (and transceivers servicing the service). Accordingly, the following additional advantages ensue:

i) Via the display element, a current shadow account balance may be checked without a need for additional devices. Insufficient balance may be detected in advance, thereby avoiding embarrassment and/or abuse.

ii) Via the above transceiver broadcasts, a user may have advanced knowledge of a service cost and determine not only if he/she has sufficient funds, but whether he/she wishes to spend the broadcasted amount on the service at hand.

iii) Via the updating of the shadow account with the actual account balance, a user is kept updated as to an actual available balance.

iv) Via a display of a balance on the card, inspection staff may confirm that a card carrier can lawfully partake, i.e. pay for a particular service. Via an automatic checking as may be done directly between transceiver and card, the inspection staff would be freed up to inspect non-ticket holders. Additionally, when a ticket fails the direct (transceiver-card) sufficient account balance query, the inspection staff may be automatically notified.

v) More than one card can be associated with an account in a remote computer, thereby providing the user with a back up to a lost card. Likewise, in the event of a lost card, the account on the remote computer can be reassigned to new cards thereby avoiding any losses.

vi) Limitations on card usage (e.g. fare or route limitations) may be preassigned and subsequently automatically detected.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawings, wherein:

FIG. 1 depicts a registration system;

FIG. 2 depicts a ticket with a display element; and

FIG. 3 depicts links among a remote computer system, a clearing system, and a card terminal.

### DETAILED DESCRIPTON OF THE INVENTION

The present invention will be described with application to railway service. Other applications, as would be appreciated by one skilled in the art, are available within the scope of the present invention. Throughout the figures, identical reference numbers are used to indicate equivalent elements or features. Throughout, the term card and ticket will be used interchangeably to indicate means for conferring payment for a service.

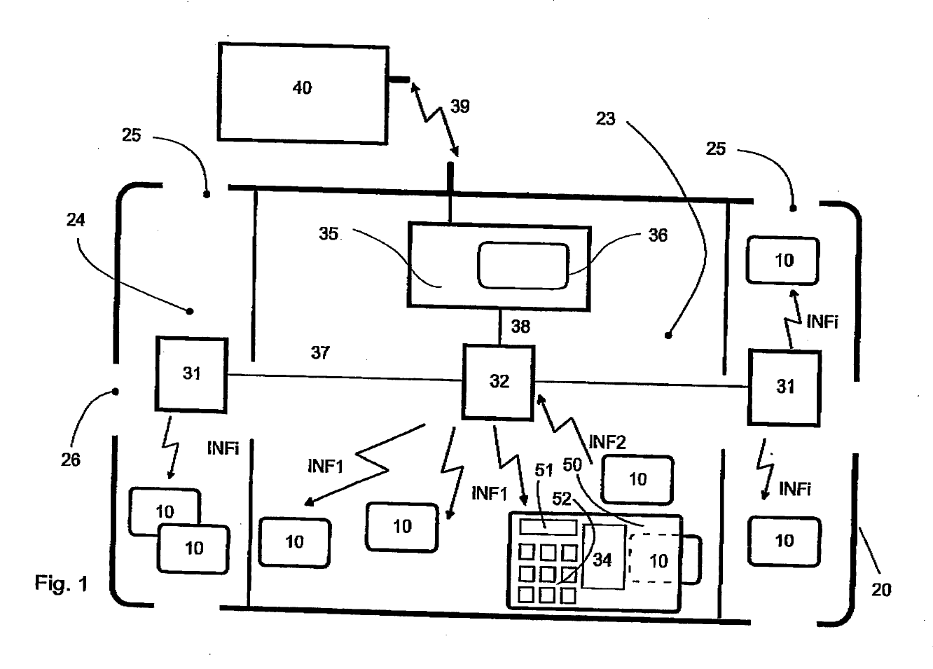

FIG. 1 depicts a layout of a railway carriage 20 having a boarding zone 25 and a passageway zone 26, both located at ends of the carriage 20. The passageway zone 26 enables the passenger to transit to another carriage 20′ of the train. The boarding zone 25 and the passageway zone 26 provide access, by way of a platform 24, to a passenger area 23. The passenger area 23 is often separated by means of an interior partition wall 21. The partition wall 21 may extend halfway between floor and ceiling and may comprise glass. Other partitions extend the full length and may comprise glass or other materials. Each platform 24 has associated with it a first transmitter unit 31 which covers a respective boarding zone with a first intermittent electromagnetic field, thereby creating a wake up zone. The boarding zone includes, a sector of approximately 3 m radius extending outside the carriage 20. The coverage is in effect regardless of whether the doors to the outside are open or if the carriage is in motion.

A second transmitter/receiver or transceiver unit 32 is assigned to the passenger area 23. The transceiver creates a registration zone within its broadcast range. The broadcast may be a second intermittent electromagnetic field. By preference, the first electromagnetic field exhibits a frequency in the near field of 7.68 MHz for example. Tickets 10 entering the boarding zone are woken up by the near field, namely, the tickets are raised from an idle state into an intermittent receive state. Waking up of the tickets 10 can however also take place in a different manner, for example by being introduced into a device or by means of contactless swiping past a device, the contactless swiping being at a distance of, for example, 25 cm. Manual activation is also possible by using a switch or the like (not shown) provided on the ticket 10. The second electromagnetic field exhibits a significantly higher frequency. As a result of frequency regulations, a frequency of 868 MHz has proven to be expedient.

The first transmitter unit 31 is linked directly or indirectly by way of links 37 and 38 with an on-board computer 35. The second transmitter/receiver unit 32 is coupled by way of link 38 with the on-board computer 35. The communication between the second transmitter/receiver unit 32 and the tickets 10 takes place by means of third and fourth data fields or information units INF1, to the ticket, and INF2, from the ticket 10, respectively. The technical procedure for this communication from a large number of tickets 10, in respect of the entry into a carriage, and the alerting of these tickets with the first transmitter unit 31, has been proposed in international application PCT/EP 00/08292 which is herein incorporated by reference. The designation of the information units INF1, INF2, INF3 in document PCT/EP 00/08292 corresponds to the designation used here for the sequence INF1, INF2, and INF3.

In one embodiment of the present invention, the information unit INF1 which is transmitted on a broadcast basis or specifically addressed by the transmitter/receiver unit 32 to the tickets 10 in the registration zone exhibits a structure in accordance with the following Table 1.

TABLE 1
Information unit INF1

| Information | |
|---|---|
| fields | Meaning |
| CYCLE2 | Time unit and time reference |
| COMMAND2 | Command to the ticket 10 |
| POSITION2 | Location |
| COURSE2 | Course number |
| DATETIME2 | Date and time |
| TYPE2 | Type of transport |
| ADDRESS2 | Address of the transmitter/receiver unit 32 |
| LOCATION2 | Location information |
| TARIFUNIT2 | Provisional tariff unit |
| : | |
| APPLICATION2 | Application |

As a result of the information fields POSITION2, COURSE2, DATETIKE2, ADDRESS2, LOCATION2 and TARIFUNIT2 being sent to a ticket 10, a data record having a structure in accordance with Table 2 may result, the data record for example being generated on the ticket 10 together with the fields of a previously transmitted information unit INF1.

TABLE 2
Data record TRAVREC

| Information | |
|---|---|
| fields | Meaning |
| BEGIN_POS | Beginning location |
| END_POS | Temporary destination |
| COURSE | Course number |
| DATETIME | Date and time |
| TYPE | Type of transport |
| ADDRESS | Address of the transmitter/receiver unit 32 |
| TARIFUNITS | Accumulated provisional tariff units |
| : | |
| : | |
| APPLICATION2 | |

As a result of the transmitted address, the course number, and the ongoing time, it is possible to continue updating a single data record TRAVREC on a ticket 10 in respect of the BEGIN_POS field while the ticket 10 is situated in a particular registration zone. If a passenger switches to a different carriage during the journey, a new data record TRAVREC is preferably constructed since the address of the transmitter/receiver unit 32 changes accordingly.

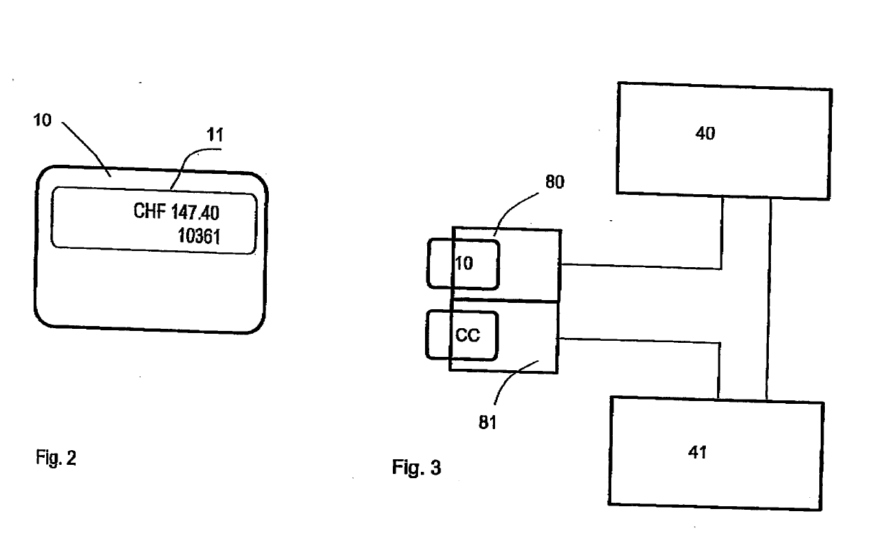

The ticket 10 contains a fictitious or shadow account whose balance can be represented either as a currency amount, such as Swiss francs, or as a points value. The account balance may be displayed on display element 11 on the ticket 10, as shown in FIG. 2. As a result of the provisional tariff unit contained in the field TARIFUNIT2, and also the time, a debit takes place from this fictitious account. Alternatively, it is also possible for the entry in the field TARIFUNIT2 to be structured such that a further debit takes place only after an indicator has changed in the field TARIFUNIT2. The provisional tariff is in contrast to the actual tariff for the service at issue.

In the reverse direction, the communication from the ticket 10 to the on-board computer 35 takes place by means of the information units INF2, whose structure is illustrated in Table 3.

TABLE 3
Information unit INF2

| Information | |
|---|---|
| fields | Meaning |
| ADDRESS3 | Received address of a transmitter/receiver |
| | unit 32 |
| COURSE2 | Course number |
| POSITION3 | Marked location |
| ACTPOSITION3 | Current position according to most recently |
| | received POSITION2 |
| DATETIME3 | Boarding date and time |
| TYPE3 | Type of ticket |
| TICKET_ID3 | Ticket number, ticket ID |
| : | |
| ATTRIBUTES3 | Attributes |
| STATE3 | Status information |

Each ticket 10 has a separate ticket number which is referred to simply as ticket ID in the following. This ticket ID is contained in the information unit INF2 in the field TICKET_ID3. Using the fields TICKET_ID3, TYPE3, DATETIME3 and should the need arise ADDRESS3, a data record COACHREC whose structure comprises at least those fields which are contained in the data record TRAVREC maintained on the ticket 10 is constructed in the on-board computer 35 for each ticket 10. Depending on the previous history, a plurality of such data records COACHREC can be created for a ticket 10 identified by means of a unique ticket ID. This is the case for example if a person happens to use the same vehicle for different journeys or if a vehicle travels on a different route, as a result of which at least the course number changes.

The data records COACHREC stored in the on-board computer 35 are transmitted by way of a link 39 to a remote computer system 40 according to instructions of the transportation company. The data records may be first data records comprising indication of registration for the service and card identification. The transmission is preferably protected, in particular the data records COACHREC stored in the on-board computer 35 are not deleted until a corresponding acknowledgment has been received from the remote computer system. An actuation element optionally available on a ticket 10 can also be used in order to display a joint journey with another person. It is possible to specify a plurality of fellow traveling persons by means of corresponding multiple actuation. This entry of such charging-related parameters is preferably made in the field ATTRIBUTES3 and transmitted to the on-board computer 35.

Anonymous accounts are maintained in a database FXACCOUNT on the computer system 40. An anonymous account is associated with a ticket 10 by way of an account ID and a ticket ID in accordance with a partial representation in Table 4:

TABLE 4
Database FXACCOUNT

| Ticket ID | Account ID | Credit balance | Expiry |
|---|---|---|---|
| 80002.34F01 | Q3-023.608 | 25.00 | 2004-12-31 |
| 10040.A6E20 | L0-839.778 | 1034.30 | 2002-06-30 |
| : | | | |
| 62235.F908A | M3-117.943 | 234.52 | 2002-04-15 |

The anonymity is guaranteed by means of the following measures: the transportation company holds a stock of tickets 10 and maintains a unique assignment of ticket ID to account ID in the database FXACCOUNT for each ticket 10. An actual account balance can be initialized by way of a deposit. The actual account may be in the storage means of computer 40 in records associated with a respective ticket or card. The assignment of account ID to ticket ID does not need to be unique. A potential passenger and customer of such a transportation company purchases a ticket 10 against the aforementioned deposit. An account ID is also provided to the passenger with the initial purchase. Preferably, the ticket and account ID are delivered in a sealed package. Other security means may also be used. Additionally, the ticket ID may be provided in an alternate form on the ticket itself, i.e. in bar code. The sale of such tickets 10 may be effected through existing sales outlets and chains.

FIG. 3 depicts example components necessary for performing a prepayment 3, i.e. a transfer or association of funds from a remote account to an account associated with the ticket 10. Herein, funds are to be transferred from an account associated with a cash card 84, such as a typical bank account, to an account associated with the card of the present invention 10.

A card read/write device 80 is connected 82 to a remote computer system 40. The card read/write device may be a standard magnetic strip or chip card reader/writer. A card terminal 81 is connected 43 to a clearing system of a financial institution 41. Card terminal 81 and read/write device 80 may further comprise a single operating unit. The card owner then uses a keypad belonging to read/write device 80 to enter a secret password associated with cash card 84. A transfer amount may also be entered. Accordingly, the specified amount is transferred. Of course other information may be entered, such as account ID. Likewise, remote payment may be effected, thereby obviating the need for having the instant card 10 present. With such embodiments, other supporting equipment, as known in the art, are employed. The credit balance maintained on the computer system 40 is sent by way of the read/write terminal 80 to the ticket 10. Topping up of a credit balance would also be conceivable with cash; to do so, a sales outlet simply requires a read/write device 80 and debit system which is used to credit the amount paid in this situation to the account of the transportation company.

If a passenger now undertakes a journey with such a ticket 10, the data records COACHREC are transmitted in the manner described above to the computer system 40 where subsequent processing takes place, including a discounting procedure, and the data records are posted to the account corresponding to the ticket 10. On the basis of the precise specifications in the data records COACHREC, the centrally stored tariff tables are used for subsequent processing. Particularly with the specifications for the time and the course and location information, in accordance with the fields in the information unit INF2, it is possible to produce a precise billing which takes into consideration the actual tariffs dependent on the distance and the time of day. On the computer system 40, the previous services purchased are maintained in an account associated with the respective ticket 10. It is thus possible to grant a discount for a frequently traveled route which corresponds to the actual tariff for a conventional route season ticket. For such a service/convenience, the user of the ticket 10 needs not do anything.

The debit made on the ticket 10 is generally higher, as a result of the application of provisional tariff units, than the actual debit to the account in the computer system 40, since a higher value is provided for the provisional tariff units than for the actual tariff units that actually come to be applied. A higher value for the tariff units that actually come to be applied is not however mandatory since quantity discounts can be provided. This also ensures that the user of such a ticket 10 is always on the safe side as far as credit balance is concerned. When the ticket 10 is next topped up, the credit balance on the ticket 10 is synchronized with the current balance. In this situation, it is possible that solely as a result of the synchronization, without any topping up, a considerable credit balance can be present again on the ticket 10.

Per the presumption that the credit balance is corrected on the ticket 10, it is also a relatively simple matter to perform a ticket inspection. By using a display unit 36 (FIG. 1) assigned to the on-board computer 35 it is possible for an inspector to determine whether passengers without sufficient funds are on board. The inspection can then simply be restricted solely to those persons who do not currently have a ticket in their possession. The detection of such passengers without sufficient funds is carried out by transmitting an information unit INF1 to the tickets 10, whose COMMAND field contains a request to transmit the account balance maintained on the ticket 10 in the ATTRIBUTES3 field of the information unit INF2. The on-board computer 35 knows as a result of the course number and current location, the minimum amount that is required to reach the next stop with an opportunity to alight. As a result, it is possible to ascertain whether sufficient funds are available for each ticket 10 located in the registration zone. Inadequate funds can also be displayed on the ticket 10, whereby the minimum amount required can be transmitted to the tickets 10 by way of the fields COMMAND2 and APPLICATION2 in the information unit INF1 on a broadcast basis, and thus all ticket owners can see whether an adequate credit balance is present for the intended journey from a plain-text or symbol display on the display element 11.

Different threshold values can be provided on the ticket 10. It is al so possible to transfer a minimum amount from transmitter unit 31 with an information unit INFi to ticket 10. As a result, the potential passenger is already informed about the presumed costs and the possible funds offered by his credit balance upon starting the journey.

For the inspection staff, an inspection device 50 (FIG. 1) is provided which comprises a fourth transmitter/receiver unit for a link to a ticket 10. Like the tickets 10, the inspection device 50 similarly comprises a transmitter/receiver module and the information relevant to the registration zone in question can be displayed directly and if need be in a comparison on the display element 51 with the data records TRAVREC stored on the ticket 10.

As a result of the fact that an account ID is known solely to one passenger, such a ticket 10 may even be lost without the credit balance also being lost. In the event of a loss, a new ticket 10 with a new ticket ID can be obtained from the transportation company and the association between ticket ID and account ID simply needs to be corrected on the computer system 40. Accordingly, it is also possible to create a list of invalid tickets 10 and transmit this by way of the link 39 to the on-board computer 25. In this way it is possible to detect tickets 10 which are invalid or reported stolen and display them on the display unit 36 of the on-board computer 35. For this purpose, additional fields are preferably maintained in the database FXACCOUNT, for example a field ATTRIBUT in which a status—also referred to as use state—is maintained for a ticket: “Stolen”, “Invalid”, “Valid”, “Complimentary”, etc. This status can also be corrected by way of an interactive operation on the remote computer system 40.

By using a database FXACCOUNT according to the partial illustration in Table 4 it is possible to assign a plurality of tickets 10 to a single such account. This is of interest particularly to families or companies since it means that further, principally volume-related discounts are possible.

Through the use of already known payment systems such as cash card, credit card, bank card and cash, many possible security concerns on the part of the financial institutions relating to the transfer of money by way of an air interface can be dispelled since the actual debit and movement of money takes place by way of known and secure paths.

The previously mentioned correction of the credit balance on ticket 10, may also occur during a first registration operation of the ticket 10. The first registration may be performed periodically, e.g. daily. During the first registration, as a result of the ticket ID being sent to the computer system 40, the actual credit balance is transmitted by way of the links 39, 38 and the information unit INF1 to the ticket 10.

In another embodiment of the present invention, the aforementioned on-board computer 35 is not required. It is possible to integrate the second transmitter/receiver unit 32, the on-board computer 35, and a third transmitter/receiver unit, for coupling with the remote computer system 40 via a single device. Depending on the field of application, it is possible to dispense with the display unit 36 and the data records COACHREC are generated in this single device, stored temporarily and transmitted on an as-required basis to a remote computer system 40.

A further application to the above embodiment includes regulating attendance of exhibitions and centers which are subdivided into a plurality of specifically chargeable zones, or, for example, different movie screens. This ensures that charging for a service purchased is directly user-targeted but is nevertheless anonymous. Furthermore, the data obtained—in the case of transportation companies the data records COACHREC obtained—can also be processed further for statistical purposes without it being possible to associate individual items of data with a particular person. As a result, tariffs may be adapted to the needs of providers and customers, and where applicable, this adaptation can also take place automatically.

The present invention may also be applied to charging on a credit basis, where it is possible to dispense with the requirement for anonymous registration and charging. To this end, an assignment of an account ID to a person simply needs to be made. In this case, it is also possible to display on the ticket 10 the cumulative total for the services purchased instead of the credit balance. By using a read/write device 80 or by transmitting it directly, the total maintained in the computer system 40 can also be transmitted to the ticket 10 and thus the true total can be displayed on the display element 11 instead of the provisional total resulting from the tariff units transmitted.

All the embodiments of the method according to the invention have been described with reference to a chargeable service. The method according to the invention is also suitable for the situation whereby when registration is performed for a ticket 10 the owner in question receives a credit, for example for registration relating to the movements of a night watchman in an area under his protection which is divided into a plurality of registration zones mentioned above.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A method of paying for a service with a ticket, said ticket comprising storage and communication means, the method comprising the steps of:
maintaining a shadow account on said ticket;
determining a provisional tariff for said service;
posting said provisional tariff to said shadow account thereby generating an updated shadow account balance, said posting being in response to a registration for said service;
generating a first data field comprising indication of said registration and ticket identification;
transmitting said data field to a computer, said computer including storage means having ticket associated records, said records including a second data field comprising indication of an actual account; and
posting an actual tariff to said actual account thereby generating an updated actual account balance.
transmitting third data fields from a transceiver to said ticket, said third data fields comprising identification of said service and said provisional tariff;
storing said third data fields in storage means of said ticket;
transmitting fourth data fields from said ticket to said transceiver, said fourth data fields comprising identification of service location and said ticket identity;
adding date and time information to said fourth data fields so as to generate modified fourth data fields
storing said modified fourth data fields in a storage means associated with said transceiver
transmitting said modified fourth data fields from said transceiver to said remote computer;
calculating an actual cost based upon at least said actual tariff, service, and service location;
booking said actual cost to said actual account; and
saving said updated actual account balance associated with said ticket in a storage medium.

2. The method according to claim 1, wherein,
said third data field further comprises said provisional tariff;
said ticket comprises a display element for displaying information; and said method further comprises the step of:
displaying said updated shadow account balance and said provisional tariff on said display.

3. The method according to claim 2, wherein,
said ticket further comprises a display; and said method further comprises the step of:
broadcasting a fifth data field so as to cause tickets located within a range of said broadcasting to display said provisional tariff and said updated shadow account balance on said display.

4. The method according to claim 3, wherein,
said step of broadcasting is performed from at least one transmitter to a plurality of areas defining at least one of a boarding zone and a passageway zone.

5. The method according to claim 3, wherein,
wherein said tickets are located within said areas.

6. The method according to claim 2, further comprising the steps of:
transmitting said updated actual modified account balance to said ticket; and
replacing said shadow account balance with said account balance.

7. The method according to claim 6, wherein said steps of transmitting said updated actual modified account balance and replacing said shadow account balance are performed periodically.

8. The method according to claim 2, wherein
said ticket further comprises an actuating element; and said method further comprising the step of:
setting at least one of a registered service and charging-related parameters by means of said actuation element.

9. The method according to claim 8, wherein said ticket comprises an on/off switch.

10. The method according to claim 3, wherein
said ticket further comprises an actuating element; and said method further comprising the step of:
setting at least one of a registered service and charging-related parameters by means of said actuation element.

11. The method according to claim 10, wherein said ticket comprises an on/off switch.

12. The method according to claim 2, wherein:
said third data field comprises and indication of said shadow account balance; and
said computer is functionally associated with said transceiver;
and further comprising the steps of:
transmitting said shadow account balance to said computer;
comparing said balance of said shadow account with said provisional tariff; and
displaying an identifier of a ticket having a shadow account balance less than said provisional tariff.

13. The method according to claim 3, wherein:
said third data field comprises and indication of said shadow account balance; and
said computer is functionally associated with said transceiver;
and further comprising the steps of:
transmitting said shadow account balance to said computer;
comparing said balance of said shadow account with said provisional tariff; and
displaying an identifier of a ticket having a shadow account balance less than said provisional tariff.

14. The method according to claim 2, wherein said step of storing is limited to fields identifying said ticket.

15. The method according to claim 14, wherein said step of storing further comprises the step of assigning a plurality of fields identifying said ticket to a one of said ticket accounts.

16. The method according to claim 3, wherein said step of storing is limited to fields identifying said ticket.

17. The method according to claim 16, wherein said step of storing further comprises the step of assigning a plurality of fields identifying said ticket to a one of said ticket accounts.

18. The method according to claim 2, wherein said steps of posting are dependent upon at least one of a sum of said actual tariff, timing of said service, and type of service.

19. The method according to claim 3, wherein said steps of posting are dependent upon at least one of a sum of said actual tariff, timing of said service, and type of service.

20. The method according to claim 2, wherein said computer is functionally associated with a database, said database comprising data records identifying said tickets, said data records periodically updated so as to indicate an updated actual account balance and ticket usage status.
